(19) United States
(12) Patent Application Publication
(10) Pub. No.: US 2024/0388358 A1
(43) Pub. Date: Nov. 21, 2024

(54) MARITIME COMMUNICATIONS SYSTEM INCLUDING VARIABLE RATE FORWARD ERROR CORRECTION AND RELATED METHODS

(71) Applicant: Speedcast Communications, Inc., Houston, TX (US)

(72) Inventors: Robert MCDERMID, Houston, TX (US); Phillip FRENCH, Dallas, TX (US); William MUDGE, Melbourne, FL (US); Kevin OTTEN, Almere (NL)

(21) Appl. No.: 18/668,072

(22) Filed: May 17, 2024

Related U.S. Application Data
(60) Provisional application No. 63/468,207, filed on May 22, 2023.
(60) Provisional application No. 63/467,608, filed on May 19, 2023.

(51) Int. Cl. H04B 7/185; H04L 1/00; H04L 41/0826; H04W 48/18

(52) U.S. Cl. CPC H04B 7/1851; H04L 1/004; H04L 41/0826; H04W 48/18

(57) ABSTRACT

A maritime communications system may include a first satellite communications network having a first current operating capacity and first cost associated therewith. The system may also include a second satellite communications network having a second current operating capacity and a second cost associated therewith. The system may further include a maritime communications terminal operable over the first satellite communications network and the second satellite communications network, and a communications management server. The communications management server may be configured to apply forward error correction (FEC) to data communications from the maritime communications terminal at a variable correction rate based upon an error rate. The communications management server may also be configured to distribute data communications between the first and second satellite communications networks based upon the variable correction rate, and the first and second current operating capacities and associated first and second costs.

### RELATED APPLICATIONS

The present application claims the priority benefit of provisional application Ser. No. 63/467,608 filed on May 19, 2023, and priority benefit of provisional application Ser. No. 63/468,207 filed on May 22, 2023, the entire contents of both of which are herein incorporated by reference.

### TECHNICAL FIELD

The present invention relates to the field of communications, and, more particularly, to maritime satellite communications and related methods.

### BACKGROUND

When ships travel across large bodies of water, such as the ocean, they rely on satellite communications to maintain contact on shore. One type of satellite is a geostationary satellite, which is in geostationary orbit about 22,000 miles above the equator, so that the satellite appears stationary at the same point in the sky. Another type of satellite is a low Earth orbiting (LEO) satellite that operates in low Earth orbit, which is a circular orbit about 100-1,250 miles above the Earth's surface and orbits the Earth about every 90-minutes.

The cost of providing satellite data communications bandwidth or capacity to satellite users may be based upon costs of development, launch, maintenance, and corresponding ground equipment. This cost may often be relatively high, and thus it may be desirable to share available capacity with multiple users.

U.S. Patent Application Publication No. 2021/0092640 to Ravishankar et al. discloses a method for establishing a communication link using a terminal configured for communicating with a plurality of radio access technologies (RATs). The RATs may include LEO satellite, MEO satellite, GEO satellite, and terrestrial landline networks. The method includes determining a priority for network traffic associated with the terminal based, at least in part, on delay sensitivity associated with the network traffic, and classifying the plurality of RATs based on suitability for carrying the network traffic having the determined priority. The method also includes transmitting and receiving the network traffic using the RAT most suitable for carrying the network traffic and available to the terminal, and dynamically monitoring RATS available to the terminal to detect if a more suitable RAT becomes available for carrying the network traffic.

### SUMMARY

A maritime communications system may include a first satellite communications network having a first current operating capacity and first cost associated therewith. The maritime communications system may also include a second satellite communications network having a second current operating capacity and a second cost associated therewith. A maritime communications terminal may be operable over the first satellite communications network and the second satellite communications network. A communications management server may be configured to apply forward error correction (FEC) to data communications from the maritime communications terminal at a variable correction rate based upon an error rate. The communications management server may further be configured to distribute data communications between the first and second satellite communications networks based upon the variable correction rate, and the first and second current operating capacities and associated first and second costs.

The communications management server may be configured to determine a cause of an increase in the variable correction rate based upon a time distribution of errors. The communication management server may distribute the data communications based upon the cause of the increase in the variable correction rate, for example.

The data communications may have data packets associated therewith. The communications management server may be configured to determine the cause of the increase in the variable correction rate based upon the time distribution of errors, and distribute the data communications based upon the cause of the increase in the variable correction rate based upon detection of the data packets being dropped, for example. The communications management server may be configured to determine the increase in the variable correction rate based upon channel congestion, and distribute the data communications based upon the channel congestion.

The second satellite communications network may include a geostationary satellite communications network, for example. The first satellite communications network may include a low-Earth orbiting (LEO) satellite network, for example.

The second current operating capacity may be greater than the first capacity. The first cost may be less than the second cost.

A method aspect is directed to a method of managing communications. The method may include using a communications management server to apply forward error correction (FEC) to data communications from a maritime communications terminal at a variable correction rate based upon an error rate. The maritime communications terminal may be operable over a first satellite communications network having a first current operating capacity and first cost associated therewith and a second satellite communications network having a second current operating capacity and a second cost associated therewith. The method may further include using the communications management server to distribute data communications between the first and second satellite communications networks based upon the variable correction rate, and the first and second capacities and associated first and second costs.

A computer readable medium aspect is directed to a non-transitory computer readable medium for managing communications. The non-transitory computer readable medium includes computer executable instructions that when executed by a processor cause the processor to perform operations that may include applying forward error correction (FEC) to data communications from a maritime communications terminal at a variable correction rate based upon an error rate. The maritime communications terminal may be operable over a first satellite communications network having a first current operating capacity and first cost associated therewith, and a second satellite communications network having a second current operating capacity and a second cost associated therewith. The operations may further include distributing data communications between the first and second satellite communications networks based upon the variable correction rate, and the first and second capacities and associated first and second costs.

### BRIEF DESCRIPTION OF THE DRAWINGS

FIG. 1 is a schematic diagram of a maritime communications system according to an embodiment.

FIG. 2 is a schematic block diagram of the maritime communications system of FIG. 1.

FIG. 3 is a flow diagram illustrating operations of the communications management server of FIG. 2.

FIG. 4 is another flow diagram illustrating more detailed operations of the communications management server of FIG. 2.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

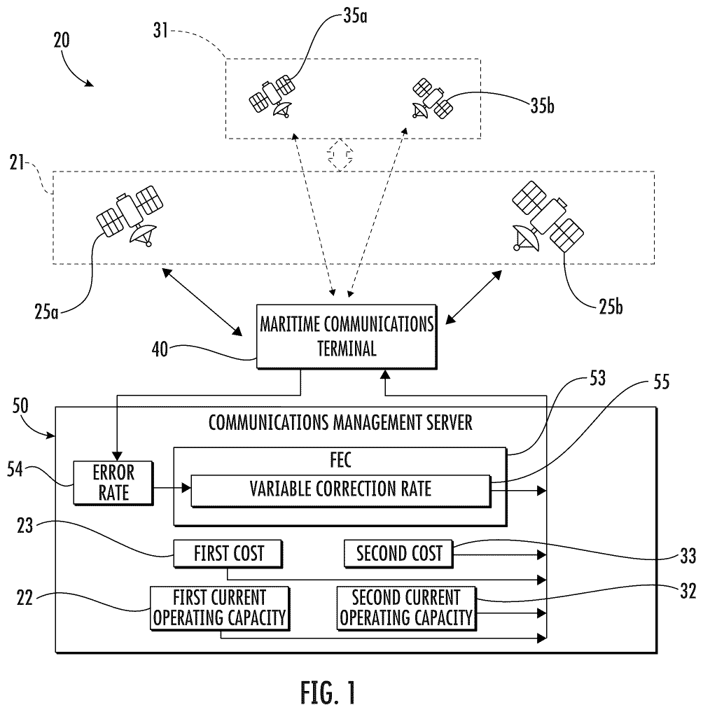

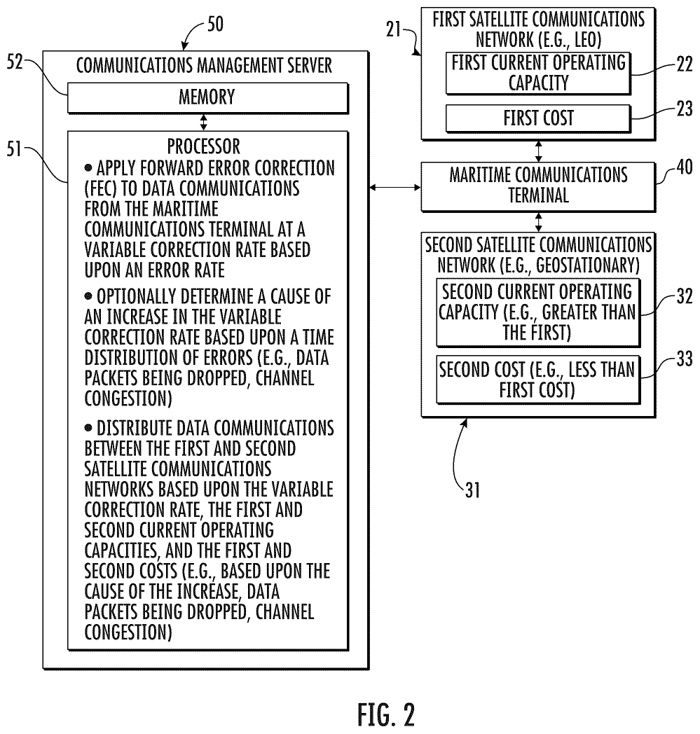

Referring initially to FIGS. 1 and 2, a maritime communications system 20 illustratively includes a first satellite communications network 21 having first satellites 25a, 25b. While two first satellites 25a, 25b are illustrated, the first satellite communications network may include any number of first satellites. The first satellite communications network 21 has a first current operating capacity 22 and first cost 23 associated therewith. The first satellite communications network 21 may be a low-Earth orbiting (LEO) satellite network, for example, including one or more LEO satellites 25a, 25b. The first satellite communications network 21 may be another type of satellite network and/or may include one or more different types of satellites. While a first satellite communications network 21 is described, those skilled in the art will appreciate that the system 20 may include a terrestrial or other communications network defining the first communications network.

The first current operating capacity 22 may include an instantaneous or real time capacity, for example, bandwidth. The first current operating capacity 22 may be represented in terms of a bit rate or bits per second, for example. The second current operating capacity 22 may be considered the maximum rate of data communications across the first satellite communications network 21. Alternatively or additionally, the first current operating capacity 22 may refer to a net bit rate, peak bit rate, information rate, or physical layer useful bit rate, channel capacity, or the maximum throughput of a logical or physical communication path in the first satellite communications network 21.

As will be appreciated by those skilled in the art, the capacity of a communications channel, such as, for example, within the first satellite communications network 21, can vary with time. The variation of capacity relative to time may affect satellite communications more than other types of communications (e.g., terrestrial), as the capacity of the satellite link or communications channel may be impacted by weather, location, interference and channel loading, for example.

The maritime communications system 20 also illustratively includes a second satellite communications network 31 having second satellites 35a, 35b. While two second satellites 35a, 35b are illustrated, the second satellite communications network 31 may include any number of second satellites. The second satellite communications network 31 has a second current operating capacity 32 and a second cost 33 associated therewith. The second satellite communications network 31 may be geostationary satellite network, for example, including one or more geostationary satellites 35a, 35b. The second satellite communications network 31 may be another type of satellite network and/or may include one or more different types of satellites. While a second satellite communications network 31 is described, those skilled in the art will appreciate that the system 20 may include a terrestrial or other communications network defining the second communications network. Moreover, while first and second satellite communications networks 21, 31 are described, there may be more than two communications networks.

The second current operating capacity 32 may include an instantaneous or real time capacity, for example, bandwidth. The second current operating capacity 32 may be represented in terms of a bit rate or bits per second, for example. The second current operating capacity 32 may be considered the maximum rate of data communications across the second satellite communications network 31. Alternatively or additionally, the second current operating capacity 32 may refer to a net bit rate, peak bit rate, information rate, or physical layer useful bit rate, channel capacity, or the maximum throughput of a logical or physical communication path in the second satellite communications network 31.

As will be appreciated by those skilled in the art, operating data communications via a satellite communications network has a cost associated therewith. The cost of data communications may be based upon current operating capacity, contracted for a given current operating capacity. For example, a data communications provider may provide a committed information rate (CIR), i.e., the guaranteed bandwidth or current operating capacity. More particularly, the CIR may be used as a way of guaranteeing that, even though data communications, e.g., over a satellite communications network, share current operating capacity or bandwidth, a given user receives at least a part of the current operating capacity, regardless of the amount of data communications. In other words, a CIR may be conceptually considered having dedicated bandwidth.

CIR may be considered to be relatively important, for example, when communicating data (e.g., communicating via the Internet) associated with an activity that is associated with a minimum bandwidth for proper communications. For example, an Internet-based phone call (VOIP) may require 20-40 kbps, depending on the type of call, and if bandwidth or current operating capacity is not available at the time of the call, the call may not occur, the call may be of low quality (e.g. noise, dropped parts), and/or the call itself may drop. However, setting a CIR or guaranteeing current operating capacity, may be relatively expensive to an end user operating one or more maritime communications terminals 40, as the guaranteed current operating capacity associated with the CIR may not be used or “sold” other users of the satellite communications network.

Accordingly, those skilled in the art will appreciate that different satellite communications networks generally have different current operating capacities and costs associated therewith. As it relates to the maritime communications system 20, the first satellite communications network 21 has a lesser current operating capacity 22 and a lesser cost 23 than the current operating capacity 32 and the cost 33 of the second satellite communications network 31. More particularly, LEO satellites forming a LEO satellite communications network (i.e., the first satellite communications network 21), are less expensive to launch into orbit than geostationary satellites (i.e., defining the second satellite communications network 31) and, due to proximity to the ground, may not require as high signal strength for data communications. Additionally, those skilled in the art will appreciate that costs may not be limited to monetary costs, but may include operational parameters such as, for example, latency, required power, jitter, etc.

A maritime communications terminal 40 is operable over the first satellite communications network 21 and the second satellite communications network 31. The maritime communications terminal 40 may be associated with a maritime vessel. The maritime communications terminal 40 may be one of several maritime communications terminals each associated with a corresponding maritime vessel, for example. The maritime communications terminal 40 may include an antenna that includes antenna feeds that are operable at different frequencies, for example, to permit communication with the first and second satellite communications networks 21, 31. The maritime communications terminal 40 may also include communications circuitry coupled to the antenna feeds and configurable for a selected antenna feed. The maritime communications terminal 40 may also include a positioner to mount the antenna to the maritime vessel and point the antenna. Further details of the maritime communications terminal may be found in U.S. Pat. No. 9,893,417, the entire contents of which are hereby incorporated by reference.

A communications management server 50 includes a processor 51 and an associated memory 52. While operations of the communications management server 50 are described herein, it should be understood that the processor 51 and the associated memory 52 cooperate to perform the operations. Additionally, the functions of the communications management server 50 may be implemented in more than one physical server using one or more physical processors. The functions also may be embodied in a virtual machine, as will be appreciated by those skilled in the art.

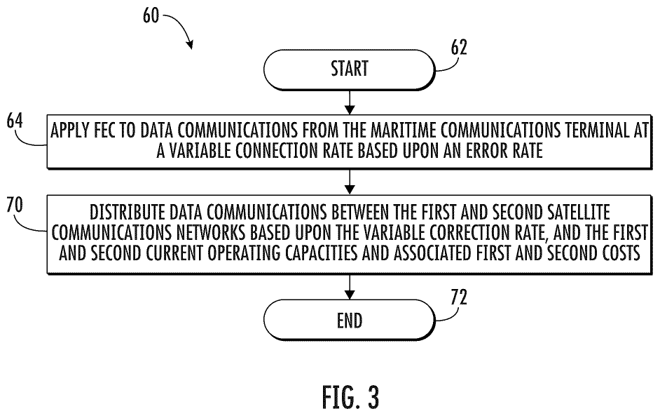

Referring now to the flowchart 60 in FIG. 3, beginning at Block 62 operations of the communications management server 50 with respect to managing data communications will now be described. The communications management server 50, at Block 64 applies forward error correction (FEC) 53 to data communications from the maritime communications terminal 40 at a variable correction rate 55 based upon an error rate 54. As will be appreciated by those skilled in the art, FEC 53 is typically applied at a fixed rate-correcting 1-bit for every x-bits. Applying FEC 53 injects redundancy into the data communications, for example, to thereby reduce errors. However, there is operational overhead associated with applying FEC 53, for example, in terms of bits in the data communications. The communications management server 50 thus operates the FEC 53 based upon a feedback loop (e.g., from an opposite end of the communications link) such that the communications management server can dynamically change the rate of correction 55 based upon a changing error rate 54 (e.g., increased error rate, an increased correction rate of FEC). In other words, the algorithm that operates the FEC rate can detect changes in channel capacity (i.e., increases or decreases). As the error rate 54 increases, the algorithm determines that channel capacity is decreasing. Conversely, as the error rate 54 decreases, the algorithm determines that the channel capacity is increasing.

An increase of the variable correction rate 55 at which the FEC 53 is applied above a threshold rate, for example, may be indicative that a channel of data communications via the satellite communications network 21, 31 may be getting full. Accordingly, it may thus be desirable to route data communications to a different channel, or different satellite communications network 21, 31.

At Block 70, the communications management server 50 distributes data communications between the first and second satellite communications networks 21, 31 based upon the variable correction rate 55 (e.g., the FEC ratio), and the first and second current operating capacities 22, 32 and associated first and second costs 23, 33. For example, the communications management server 50 may move or transfer a threshold amount of data communications from the first satellite communications network 21 to the second satellite communications network 31. The amount of data communications distributed may be less than all the data communications, for example, to obtain the threshold FEC rate 55. In some embodiments, the communications management server 50 may transfer all of the data communications from the first satellite communications network 21 to the second satellite communications network 31. In some embodiments, the communications management server 50 may distribute the data communications to obtain a desired cost in addition to the desired variable correction rate and/or the desired operating capacities (i.e., to achieve a desired variable correction rate, desired current capacities, and/or desired costs). Operations end at Block 72.

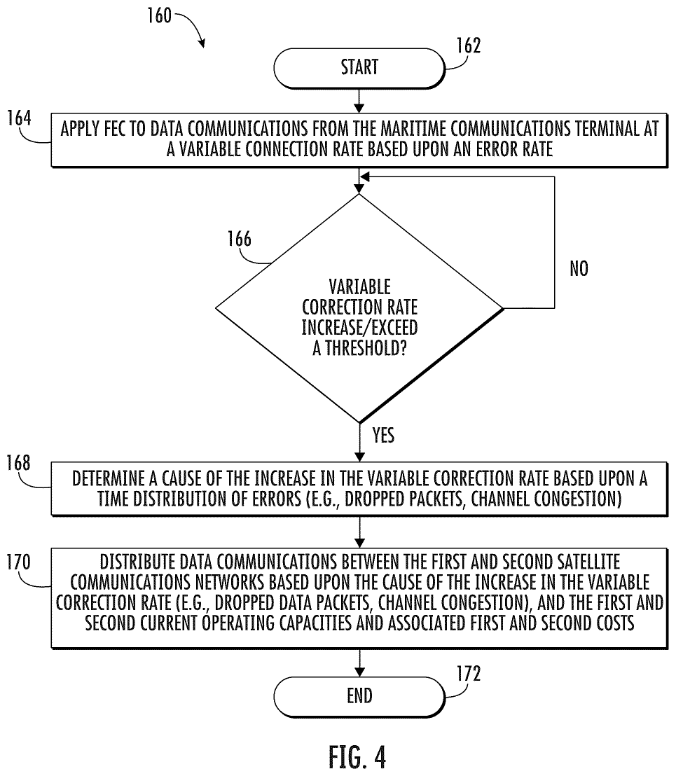

Referring now to the flowchart 160 in FIG. 4, beginning at Block 162, further details of operations of the communications management server 50 with respect to managing data communications will now be described. The communications management server 50, at Block 164 applies FEC 53 to data communications from the maritime communications terminal 40 at a variable correction rate based upon an error rate 54. Details of the application of the FEC 53 to the data communications form the maritime communications terminal 40 at the variable correction rate 55 based upon the error rate are described above.

At Block 166, the communications management server 50 determines whether the error rate 54, and thus the variable correction rate 55 has increased, for example, above a threshold and/or relative to a previous determination. If, at Block 166, the variable correction rate 55 has remained constant or decreased, the FEC 53 is applied at an updated variable correction rate (Block 164). If, at Block 166, the variable correction rate 55 increased, the communications management server 50 determines a cause of the increase based upon a time distribution of errors (Block 168). For example, the cause of the increase in the variable correction rate may be determined to be dropped data packets. If, at Block 166, the variable correction rate 55 does not increase, the communications management server 50 polls for an increase, for example (e.g., incrementally increase the data rate). Of course, in embodiments, the communications management server 50 may perform other and/or additional operations if there is no increase in the variable correction rate, for example, predictively distribute the data communications based upon a predicted increase in the variable correction rate (e.g., based upon a machine learning algorithm).

Those skilled in the art will appreciate that the communications management server 50 may determine data packet loss by any one or more of synthetic monitoring (e.g., generating simulated network traffic through the first and/or second satellite communications networks 21, 31), packet capture processes, a ping operation (e.g. sending an echo request to a designed IP address and measuring the response time, a longer or no response being indicative of dropped data packets), and a traceroute operation (e.g., tracing the path of packets between the source and destination, determining the response times from each hop therebetween). Packet loss in a satellite communications network, for example, in the first and second satellite communications networks 21, 31 may be caused by weather, geographic position relative to the satellites, and/or obstacles, including terrestrial obstacles.

The cause of the increase in the variable correction rate may alternatively or additionally be channel congestion. For example, the communications management server 50 may identify network congestion based upon a lack of sufficient bandwidth, an increase in data communications latency, jitter, data packet collisions, and/or data packet retransmissions. Those skilled in the art will appreciate that channel or network congestion in a satellite network may result from undesirable or overhead traffic and/or misconfigured traffic, for example.

The communications management server 50, at Block 170 distributes the data communications based upon the cause of the increase in the variable correction rate 55. For example, the communications management server 50 may distribute the data communications based upon detection of dropped data packets and/or channel congestions. The communications management server 50 may distribute the data communications between the first and second satellite communications networks 21, 31 at any amount. For example, the communications management server 50 may distribute data communications (e.g., initial data communications) to the first satellite communications network 21, since the first satellite communications network may have a lower cost 23 than the cost 33 of second satellite data communications network 31. However, as the correction rate of the applied FEC increases (e.g., if less packets are dropped or channel congestion decreases), the communications management server 50 may move some or all of the data communications to the second satellite communications network 31.

In an example implementation, a given user operating one or more maritime communications terminals 40 may have a contracted CIR. Data communications may initially be via the first satellite network 21. When the quality of the data communications on the first satellite network 21 falls below a threshold CIR associated with the contracted CIR (e.g., as determined by the variable correction rate, and caused by data packet loss, congestion), the communication management server 50 may, to meet the CIR, switch at least some of the data communications to the second satellite communications network 31, which has a higher current operating capacity, but comes at a higher cost. The communications management server 50 may only distribute an amount of data communications to the second satellite communications network 31 to meet the threshold associated with CIR and/or the CIR itself. Moreover, as the quality of the data communications on the first satellite network 21 increases, the communications management server 50 may distribute at least some of the data communications back to the first satellite communications network from the second satellite communications network 31.

As will be appreciated by those skilled in the art, the maritime communications system 20 may thus advantageously permit data communications quality to be maintained while also maintaining a desired cost, for example, to meet or satisfy a desired or contracted CIR. Operations end at Block 172.

A method aspect is directed to a method of managing communications. The method includes using a communications management server 50 to apply forward error correction (FEC) 53 to data communications from a maritime communications terminal 40 at a variable correction rate 55 based upon an error rate 54. The maritime communications terminal 40 may be operable over a first satellite communications network 21 having a first current operating capacity 22 and first cost 23 associated therewith and a second satellite communications network 31 having a second current operating capacity 32 and a second cost 33 associated therewith. The method further includes using the communications management server 50 to distribute data communications between the first and second satellite communications networks 21, 31 based upon the variable correction rate 55, and the first and second capacities 22, 32 and associated first and second costs 23, 33.

A computer readable medium aspect is directed to a non-transitory computer readable medium for managing communications. The non-transitory computer readable medium includes computer executable instructions that when executed by a processor 51 cause the processor to perform operations that include applying forward error correction (FEC) 53 to data communications from a maritime communications terminal 40 at a variable correction rate 55 based upon an error rate 54. The maritime communications terminal 40 may be operable over a first satellite communications network 21 having a first current operating capacity 22 and first cost 23 associated therewith, and a second satellite communications network 31 having a second current operating capacity 32 and a second cost 33 associated therewith. The operations further include distributing data communications between the first and second satellite communications networks 21, 31 based upon the variable correction rate 55, and the first and second capacities 22, 32 and associated first and second costs 23, 33.

In another embodiment, the system may include one or more terrestrial and/or maritime communications networks. The communications networks may be considered wide area network (WAN) links and may include a satellite communications link, for example. The WAN links each have different performance characteristics, and collectively have mixed performance characteristics that are based upon the collective capabilities of the respective WAN links. For example, a LEO link has different performance characteristics than the GEO link, and also different from a 5G terrestrial link (e.g., in terms of capacity, latency, and coverage). At least one of the WAN links defines a variable capacity link (e.g., Starlink, Cellular, 4G, 5G). The system, and more particularly, the communications management server, perform rules-based traffic steering with real time feedback on the WAN link performance (e.g., either individually or collectively). The communications management server executes the rules based upon the WAN links and associated performance (i.e., distributes the data communications based upon the WAN link performance(s) and the associated or corresponding rules.

While several embodiments have been described herein, it should be appreciated by those skilled in the art that any element or elements from one or more embodiments may be used with any other element or elements from any other embodiment or embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A maritime communications system comprising:
a first satellite communications network having a first current operating capacity and first cost associated therewith;
a second satellite communications network having a second current operating capacity and a second cost associated therewith;
a maritime communications terminal operable over the first satellite communications network and the second satellite communications network; and
a communications management server configured to
apply forward error correction (FEC) to data communications from the maritime communications terminal at a variable correction rate based upon an error rate, and
distribute data communications between the first and second satellite communications networks based upon the variable correction rate, and the first and second current operating capacities and associated first and second costs.

2. The maritime communications system of claim 1 wherein the communications management server is configured to determine a cause of an increase in the variable correction rate based upon a time distribution of errors, and distribute the data communications based upon the cause of the increase in the variable correction rate.

3. The maritime communications system of claim 2 wherein the data communications has data packets associated therewith; and wherein the communications management server is configured to determine the cause of the increase in the variable correction rate based upon the time distribution of errors, and distribute the data communications based upon the cause of the increase in the variable correction rate based upon detection of the data packets being dropped.

4. The maritime communications system of claim 2 wherein the communications management server is configured to determine the increase in the variable correction rate based upon channel congestion, and distribute the data communications based upon the channel congestion.

5. The maritime communications system of claim 1 wherein the second satellite communications network comprises a geostationary satellite communications network.

6. The maritime communications system of claim 1 wherein the first satellite communications network comprises a low-Earth orbiting (LEO) satellite network.

7. The maritime communications system of claim 1 wherein the second currently operating capacity is greater than the first capacity.

8. The maritime communications system of claim 1 wherein the first cost is less than the second cost.

9. A communications management server comprising:
a processor and an associated memory configured to
apply forward error correction (FEC) to data communications from a maritime communications terminal at a variable correction rate based upon an error rate, the maritime communications terminal operable over a first satellite communications network having a first current operating capacity and first cost associated therewith, and a second satellite communications network having a second current operating capacity and a second cost associated therewith, and
distribute data communications between the first and second satellite communications networks based upon the variable correction rate, and the first and second capacities and associated first and second costs.

10. The communications management server of claim 9 wherein the processor is configured to determine a cause of an increase in the variable correction rate based upon a time distribution of errors, and distribute the data communications based upon the cause of the increase in the variable correction rate.

11. The communications management server of claim 10 wherein the data communications have data packets associated therewith; and wherein the processor is configured to determine the cause of the increase in the variable correction rate based upon the time distribution of errors, and distribute the data communications based upon the cause of the increase in the variable correction rate based upon detection of the data packets being dropped.

12. The communications management server of claim 10 wherein the processor is configured to determine the increase in the variable correction rate based upon channel congestion, and distribute the data communications based upon the channel congestion.

13. The communications management server of claim 9 wherein the second satellite communications network comprises a geostationary satellite communications network.

14. The communications management server of claim 9 wherein the first satellite communications network comprises a low-Earth orbiting (LEO) satellite network.

15. The communications management server of claim 9 wherein the second capacity is greater than the first capacity.

16. The communications management server of claim 9 wherein the first cost is less than the second cost.

17. A method of managing communications comprising:
using a communications management server to
apply forward error correction (FEC) to data communications from a maritime communications terminal at a variable correction rate based upon an error rate, the maritime communications terminal operable over a first satellite communications network having a first current operating capacity and first cost associated therewith and a second satellite communications network having a second current operating capacity and a second cost associated therewith, and
distribute data communications between the first and second satellite communications networks based upon the variable correction rate, and the first and second capacities and associated first and second costs.

18. The method of claim 17 wherein using the communications management server comprises using the communications management server to determine a cause of an increase in the variable correction rate based upon a time distribution of errors, and distribute the data communications based upon the cause of the increase in the variable correction rate.

19. The method of claim 18 wherein the data communications have data packets associated therewith; and wherein using the communications management server comprises using the communications management server to determine the cause of the increase in the variable correction rate based upon the time distribution of errors, and distribute the data communications based upon the cause of the increase in the variable correction rate based upon detection of the data packets being dropped.

20. The method of claim 18 wherein using the communications management server comprises using the communications management server to determine the increase in the variable correction rate based upon channel congestion, and distribute the data communications based upon the channel congestion.

21. A non-transitory computer readable medium for managing communications, the non-transitory computer readable medium comprising computer executable instructions that when executed by a processor cause the processor to perform operations comprising:
applying forward error correction (FEC) to data communications from a maritime communications terminal at a variable correction rate based upon an error rate, the maritime communications terminal operable over a first satellite communications network having a first current operating capacity and first cost associated therewith and a second satellite communications network having a second current operating capacity and a second cost associated therewith; and
distributing data communications between the first and second satellite communications networks based upon the variable correction rate, and the first and second capacities and associated first and second costs.

22. The non-transitory computer readable medium of claim 21 wherein the operations comprise determining a cause of an increase in the variable correction rate based upon a time distribution of errors, and distributing the data communications based upon the cause of the increase in the variable correction rate.

23. The non-transitory computer readable medium of claim 22 wherein the data communications have data packets associated therewith; and wherein the operations comprise determining the cause of the increase in the variable correction rate based upon the time distribution of errors, and distributing the data communications based upon the cause of the increase in the variable correction rate based upon detection of the data packets being dropped.

24. The non-transitory computer readable medium of claim 22 wherein the operations comprise determining the increase in the variable correction rate based upon channel congestion, and distributing the data communications based upon the channel congestion.

25. A communications system comprising:
a plurality of communications networks each having a variable operating performance associated therewith, at least one of the plurality of communications networks comprising a satellite communications network;
a communications terminal operable over the plurality of communications networks; and
a communications management server configured to
apply forward error correction (FEC) to data communications from the communications terminal at a variable correction rate based upon an error rate, and
distribute data communications between the plurality of communications networks based upon the variable correction rate, and the variable operating performances.

26. The communications system of claim 25 wherein the communications management server is configured to determine a cause of an increase in the variable correction rate based upon a time distribution of errors, and distribute the data communications based upon the cause of the increase in the variable correction rate.

27. The communications system of claim 26 wherein the data communications has data packets associated therewith; and wherein the communications management server is configured to determine the cause of the increase in the variable correction rate based upon the time distribution of errors, and distribute the data communications based upon the cause of the increase in the variable correction rate based upon detection of the data packets being dropped.

28. The communications system of claim 26 wherein the communications management server is configured to determine the increase in the variable correction rate based upon channel congestion, and distribute the data communications based upon the channel congestion.

29. The communications system of claim 25 wherein the at least one satellite communications network comprises a geostationary satellite communications network.

30. The communications system of claim 25 wherein the at least one satellite communications network comprises a low-Earth orbiting (LEO) satellite network.

31. The communications system of claim 25 wherein at least one of the plurality of communications networks comprises a terrestrial communications network.

32. A communications management server comprising:
a processor and an associated memory configured to
apply forward error correction (FEC) to data communications from a communications terminal at a variable correction rate based upon an error rate, the communications terminal operable over a plurality of communications networks each having a variable operating performance associated therewith, at least one of the plurality of communications networks comprising a satellite communications network, and
distribute data communications between the plurality of communications networks based upon the variable correction rate, and the variable operating performances.

33. The communications management server of claim 32 wherein the processor is configured to determine a cause of an increase in the variable correction rate based upon a time distribution of errors, and distribute the data communications based upon the cause of the increase in the variable correction rate.

34. The communications management server of claim 33 wherein the data communications have data packets associated therewith; and wherein the processor is configured to determine the cause of the increase in the variable correction rate based upon the time distribution of errors, and distribute the data communications based upon the cause of the increase in the variable correction rate based upon detection of the data packets being dropped.

35. The communications management server of claim 33 wherein the processor is configured to determine the increase in the variable correction rate based upon channel congestion, and distribute the data communications based upon the channel congestion.

36. The communications management server of claim 32 wherein the at least one satellite communications network comprises a geostationary satellite communications network.

37. The communications management server of claim 32 wherein the at least one satellite communications network comprises a low-Earth orbiting (LEO) satellite network.

38. The communications management server of claim 32 wherein at least one of the plurality of communications networks comprises a terrestrial communications network.

39. A method of managing communications comprising:
using a communications management server to
apply forward error correction (FEC) to data communications from a communications terminal at a variable correction rate based upon an error rate, the communications terminal operable over a plurality of communications networks each having a variable operating performance associated therewith, at least one of the plurality of communications networks comprising a satellite communications network, and
distribute data communications between the first and second satellite communications networks based upon the variable correction rate, and the first and second capacities and the variable operating performances.

40. The method of claim 39 wherein using the communications management server comprises using the communications management server to determine a cause of an increase in the variable correction rate based upon a time distribution of errors, and distribute the data communications based upon the cause of the increase in the variable correction rate.

41. The method of claim 40 wherein the data communications have data packets associated therewith; and wherein using the communications management server comprises using the communications management server to determine the cause of the increase in the variable correction rate based upon the time distribution of errors, and distribute the data communications based upon the cause of the increase in the variable correction rate based upon detection of the data packets being dropped.

42. The method of claim 40 wherein using the communications management server comprises using the communications management server to determine the increase in the variable correction rate based upon channel congestion, and distribute the data communications based upon the channel congestion.

43. A non-transitory computer readable medium for managing communications, the non-transitory computer readable medium comprising computer executable instructions that when executed by a processor cause the processor to perform operations comprising:
applying forward error correction (FEC) to data communications from a communications terminal at a variable correction rate based upon an error rate, the communications terminal operable over a plurality of communications networks each having a variable operating performance associated therewith, at least one of the plurality of communications networks comprising a satellite communications network; and
distributing data communications between the first and second satellite communications networks based upon the variable correction rate, and the variable operating capacities.

44. The non-transitory computer readable medium of claim 43 wherein the operations comprise determining a cause of an increase in the variable correction rate based upon a time distribution of errors, and distributing the data communications based upon the cause of the increase in the variable correction rate.

45. The non-transitory computer readable medium of claim 44 wherein the data communications have data packets associated therewith; and wherein the operations comprise determining the cause of the increase in the variable correction rate based upon the time distribution of errors, and distributing the data communications based upon the cause of the increase in the variable correction rate based upon detection of the data packets being dropped.

46. The non-transitory computer readable medium of claim 44 wherein the operations comprise determining the increase in the variable correction rate based upon channel congestion, and distributing the data communications based upon the channel congestion.
